(19) United States
(12) Patent Application Publication
(10) Pub. No.: US 2021/0223165 A1
(43) Pub. Date: Jul. 22, 2021

(54) ULTRASENSITIVE DISPLACEMENT SENSING METHOD AND DEVICE BASED ON LOCAL SPIN CHARACTERISTICS

(71) Applicant: SHENZHEN UNIVERSITY, Shenzhen (CN)

(72) Inventors: Luping Du, Shenzhen (CN); Aiping Yang, Shenzhen (CN); Xiaocong Yuan, Shenzhen (CN)

(21) Appl. No.: 16/303,773

(22) PCT Filed: Oct. 13, 2017
(86) PCT No.: PCT/CN2017/105961

§ 371 Date: Nov. 21, 2018

(51) Int. Cl. G01N 21/19; G01N 21/21

(52) U.S. Cl. CPC G01N 21/19; G01N 21/21

(57) ABSTRACT

This disclosure is applicable to the field of optical measurement technology, and provides a method and device for ultrasensitive displacement sensing based on local spin characteristics, the method comprises: using an excitation light to excite and generate a near-field optical vortex field, NF-OV in which a local spin state linearly changes with a position at a detection; coupling the local spin state of the NF-OV to a far-field by using a nanostructure, so as to obtain elliptically polarized light; and detecting the spin degree of elliptically polarized light to obtain displacement information of the position at the detection. The sensing method provided by the disclosure can obtain accurate displacement information, has high sensitivity, low cost and high practical value.

### TECHNICAL FIELD

The present disclosure relates to the field of optical measurement technology, and in particular relates to an ultrasensitive displacement sensing method and a device based on local spin characteristics.

### BACKGROUND

Nanotechnology has led a new industrial revolution in the 21st century. It continues to penetrate into areas like information technology, biotechnology, medicine, energy and environment, and has gradually made significant progress. Precise nano-measurement technology is the premise and catalyst for the development of nanotechnology. Technology begins with measurement. Measurement technology is also an important symbol of science and technology in a nation. The development of nanotechnology requires people to have a full understanding on the Nano-world. Therefore, there is a need for scientific methods and key technologies capable of measuring, operating, and assembling at the nanoscale or even smaller scales, as well as corresponding equipment and facilities.

Precision measurement technology can also be referred as high-precision ultrasensitive displacement sensing technology. At present, it mainly can be used in the following aspects: I) Ultraprecision machining technology and micromechanics manufacturing technology, these technologies can only be done with ultrahigh precision positioning. For example, the nano-translation stage (PI) commonly used in laboratories requires to be supported by precise positioning technology; II) Bioengineering technology and medical technology, for example, microsurgery is performed by a micro-motion robot with a sensor, which can greatly reduce the burden on doctors, shorten the surgery time, conserve the patient's physical energy, and improve the success rate, thereby having broad application prospects; the development of this technology is highly dependent on high-precision ultrasensitive displacement sensing; and III) Scanning probe microscope, sensitive displacement sensing technology is one of the key technologies of scanning probe microscope, and directly affects the imaging structure and manufacturing of microscope. In addition to the important applications in the above aspects, high-precision ultrasensitive displacement sensing also has important application value in the fields like fiber optic butting, magnetic storage devices, and nanometer metrology.

The current high-precision ultrasensitive displacement sensing technology is mostly realized by using one kind of electrical method through a flexible feedback mechanism, and another kind of traditional optical imaging method, i.e., traditional optical measurement method. These two kinds of detection methods have their own advantages and disadvantages. Specifically, the electrical method can reach high precision, but it requires incalculable costs to eliminate noise; while regarding the traditional optical imaging method, due to the limitation of optical diffraction limits, the measurement sensitivity thereof is much lower than that of the electrical method, and the accuracy thereof is difficult to be further improved.

Therefore, there is a need for a new high-precision ultrasensitive displacement sensing technology, in order to achieve ultrasensitive and high-precision displacement sensing.

### SUMMARY

The present disclosure provides an ultrasensitive displacement sensing method and a device based on local spin characteristics; and aims to provide a new optical sensing method which can obtain ultrasensitive and high-precision displacement information, by performing a detection through coupling a local spin state of NF-OV optical field to a far-field according to the characteristics that the local spin state of NF-OV optical field linearly changes with a detecting position.

The present disclosure provides an ultrasensitive displacement sensing method based on local spin characteristics, the method includes:

exciting and generating a near-field optical vortex field, NF-OV, in which a local spin state linearly changes with a detecting position by an excitation light;

coupling the local spin state of the NF-OV to a far-field by using a nanostructure, so as to obtain elliptically polarized light; and

detecting the spin degree of elliptically polarized light, to obtain displacement information of the detecting position.

Further, the near-field optical vortex field may be a focusing field with a vortex phase.

Further, the near-field optical vortex field may be an evanescent field with a vortex phase.

Further, the evanescent field may be a surface plasmon optical vortex field, SPOV with a special distributed spin circular dichroism after modulation.

The generating a near-field optical vortex field, NF-OV, in which a local spin state linearly changes with a detecting position by excitation of an excitation light includes:

using a liquid crystal phase modulation slide to modulate an incident beam to obtain a modulated outgoing beam; and using the modulated outgoing beam as an excitation light to excite and generate a SPOV with a special distributed spin circular dichroism, in which a local spin state linearly changes with a detecting position.

Further, the incident beam includes a superposed left-handed beam and right-handed beam, the modulated outgoing beam is a beam formed by moving the left-handed beam to the left by a predetermined distance from the center of the incident beam and moving the right-handed beam to the right by a predetermined distance from the center of the incident beam.

The present disclosure also provides an ultrasensitive displacement sensing device based on local spin characteristics, the device includes:

an excitation unit configured to excite by an excitation light and generate a near-field optical vortex field, NF-OV, in which a local spin state linearly changes with a detecting position;

a response unit configured to couple the local spin state of the NF-OV to a far-field by using a nanostructure, so as to obtain elliptically polarized light; and

a detection unit configured to detect the spin degree of elliptically polarized light to obtain displacement information of the detecting position.

Further, the near-field optical vortex field may be a focusing field with a vortex phase.

Further, the near-field optical vortex field may be an evanescent field with a vortex phase.

Further, the evanescent field may be a surface plasmon optical vortex field, SPOV with a special distributed spin circular dichroism after modulation.

Specifically, the excitation unit is configured to modulate an incident beam by using a liquid crystal phase modulation slide, to obtain a modulated outgoing beam; and to use the modulated outgoing beam as an excitation light, to excite and generate a SPOV with a special distributed spin circular dichroism, in which a local spin state linearly changes with a detecting position.

Further, the incident beam includes a superposed left-handed beam and right-handed beam, the modulated outgoing beam is a beam formed by moving the left-handed beam to the left by a predetermined distance from the center of the incident beam and moving the right-handed beam to the right by a predetermined distance from the center of the incident beam.

Compared with the prior art, the present disclosure achieves the following beneficial effects: regarding the ultrasensitive displacement sensing method and device based on the local spin characteristic of the present disclosure, first, the excitation light is excited to generate NF-OV in which the local spin state linearly changes with the detecting position; then, the nanostructure is used to couple the local spin state of the NF-OV to the far-field, so as to obtain elliptically polarized light; finally, the spin degree of elliptically polarized light is detected to obtain displacement information of the detecting position. The present disclosure can obtain displacement information by performing the detection through coupling the local spin state of NF-OV optical field to the far-field according to the characteristics that the local spin state of NF-OV optical field linearly changes with the detecting position, compared with the prior art. The sensing method provided by the present disclosure can obtain accurate displacement information, has high sensitivity, low cost and high practical value.

### BRIEF DESCRIPTION OF THE DRAWINGS

FIG 1 is a schematic flow chart showing an ultrasensitive displacement sensing method based on local spin characteristics, according to an embodiment of the present disclosure;

FIG. 2A is a schematic view showing a vortex in a plane of a first-order SPOV optical field, according to an embodiment of the present disclosure;

FIG. 2B is a schematic view showing the intensity distribution of a spin circular dichroism in a plane of a first-order SPOV optical field, according to an embodiment of the present disclosure;

FIG. 2C shows a simulation result for the characteristic curve of spin characteristics of SPOV optical field changing with the position, according to an embodiment of the present disclosure, in which a straight line portion may be used for position detecting;

FIG. 3A shows an intensity diagram of SPOV lateral field with a special distributed spin, according to an embodiment of the present disclosure;

FIG. 3B is a diagram showing a spin-circular dichroic intensity distribution of SPOV lateral field with a special distributed spin, according to an embodiment of the present disclosure;

FIG. 3C is a schematic view showing the linearity in the SPOV lateral field with a special distributed spin used to detect the spin distribution of the displacement detection region, according to an embodiment of the present disclosure;

FIG. 4 is a schematic block diagram of the ultrasensitive displacement sensing device based on local spin characteristics, according to an embodiment of the present disclosure.

### DETAILED DESCRIPTION

The present disclosure will be further described in detail with reference to the accompanying drawings and embodiments, in order to understand objects, technical solutions and advantages of the present disclosure more clearly. It is to be understood that the specific embodiments described herein are merely for explanation, and are not intended to limit the present disclosure.

In the prior art, neither the electrical displacement sensing method nor the traditional optical displacement sensing method can achieve ultrasensitive and high-precision displacement sensing.

In order to solve the above technical problem, the present disclosure proposes an ultrasensitive displacement sensing method and device based on local spin characteristics, in which displacement information can be obtained by performing the detection through coupling the local spin state of near-field optical vortex field to the far-field according to the characteristics that the local spin state of near-field optical vortex field linearly changes with the detecting position.

The following refers to the detailed description of the ultrasensitive displacement sensing method based on local spin characteristics proposed by the present disclosure, which is a novel optical method for implementing ultrasensitive displacement sensing.

Because the traditional optical measurement method is limited by the optical diffraction limits, the measurement sensitivity thereof is much lower than that of the electrical method. Near-field optics studies the distribution of optical fields over a range of wavelengths from the surface of an object, overcoming the optical diffraction limit, achieving smaller resolution sizes and smaller mark sizes with respect to far-field optics. In addition, under near-field situation, polarization vector characteristics of the optical field are more pronounced, especially when the optical field has orbital angular momentum (near-field optical vortex field), the special orbit-spin angular momentum hybrid characteristics thereof provide the possibility for more precise optical measurements. These characteristics are applied to the displacement sensing technology, to achieve the displacement sensing at the angstrom level by detecting the local spin characteristics of the near-field optical vortex field.

Taking the surface plasmon polariton (SPP) formed on the surface of the metal film as an example, the SPP optical field on the surface of the metal film has local polarization characteristics, and such local polarization characteristics do not change with the electric field propagation. Detecting the local polarization characteristics of optical field can obtain accurate positioning and position detection. Two components Ex and Ey in the plane of SPP optical field are used. Specifically, if there is a fixed phase difference of pi/2 or −pi/2 between these two components, then it is possible to obtain a near-field polarization state (i.e., the longitudinal spin) that is ideally and continuously changing as the amplitude changes and is easy to be measured, and to determine the spin characteristics thereof, thereby achieving ultrasensitive displacement sensing.

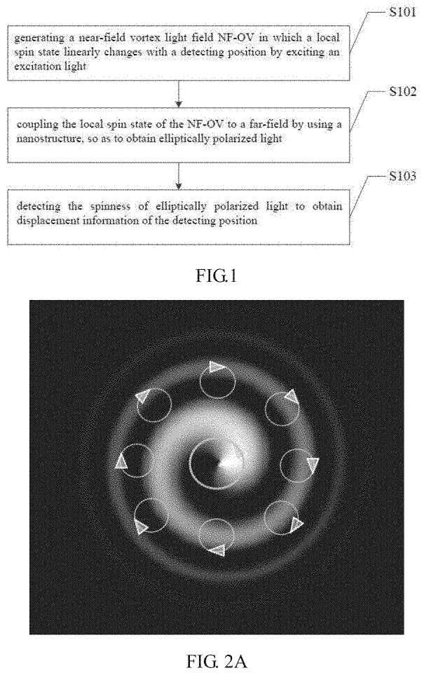

Based on this, an embodiment of the present disclosure provides an ultrasensitive displacement sensing method based on local spin characteristics. As shown in FIG. 1, the method includes the following steps.

At step S101, an excitation light is excited to generate a near-field optical vortex field, NF-OV in which a local spin state linearly changes with a detecting position.

Specifically, the near-field optical vortex field may be a focusing field with a vortex phase or an evanescent field with a vortex phase.

More specifically, the evanescent field may be a radial surface plasmon optical vortex field, SPOV, or may be a surface plasmon optical vortex field, SPOV with a special distributed spin-circular dichroism after modulation.

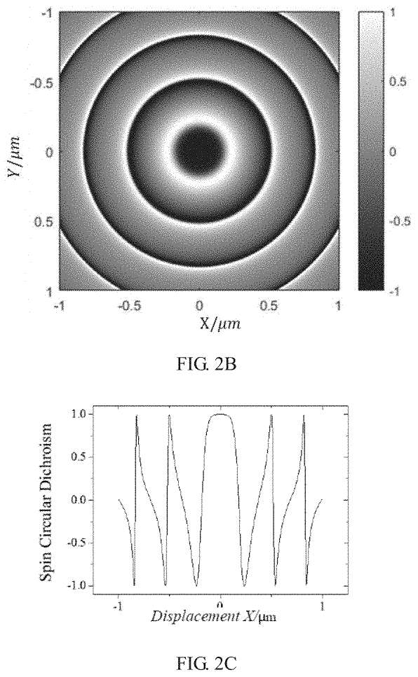

Specifically, in principle, the radial vortex light can be used as the excitation light, and can excite the surface plasmon propagation field SPP, to generate the radial SPOV in which the near-field local spin state linearly changes with the detecting position. The SPOV having a spiral phase is shown in FIG. 2A, and has a fixed phase difference of pi/2 or −pi/2 between the Ex and Ey components thereof to form a local spin. Then, the local spin of the SPOV has the pre-changing with position characteristics which can be used for performing the displacement sensing. In addition, FIG. 2A shows the first-order SPOV optical field and the local spin thereof, FIG. 2B shows the intensity distribution of spin circular dichroism in the plane of first-order SPOV optical field, and FIG. 2C shows the simulation result for the characteristic curve of spin characteristics of SPOV optical field changing with position according to an embodiment of the present disclosure, in which the straight line portion may be used for position detection.

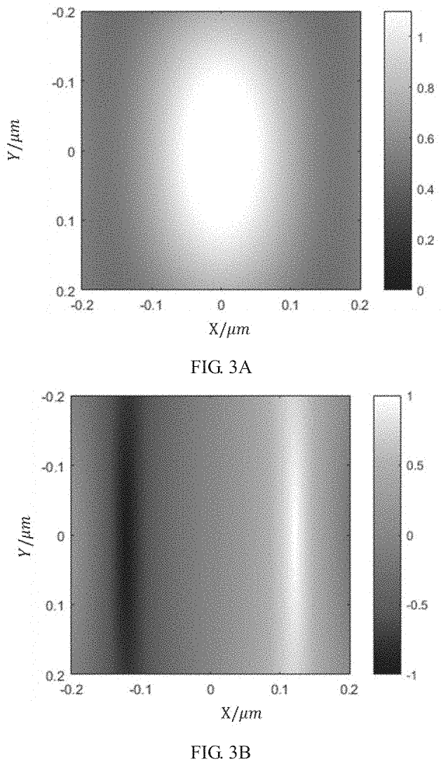

Actually, in practices, when the single first-order SPOV optical field excited as the above is used, it is difficult to ensure the accuracy of a single dimension in the actual displacement detection process due to its circular symmetry. Therefore, the excitation light is further modulated to generate a SPOV optical field with a special distributed spin, to reduce the difficulty of detection and to improve the practical values. Specifically, a liquid crystal phase modulation slide whose function is to modulate the phase of the left-handed (right-handed) incident beam is designed, so that the center of the outgoing near-field optical vortex field is shifted to the left (right) by a certain degree relative to the center of the original optical field. When linearly polarized light (the superposition of left-handed and right-handed lights) is used as the incident light, both the optical field shifted to the left (minus first order optical vortex field) and the optical field shifted to the right (plus first order optical vortex field) can be obtained at the same time. These two optical fields will be superimposed to form a new optical field, which is called as a conjugate optical vortex field misalignment superposition technique. The new light beam is used as the excitation light to excite and generate a SPOV with a special distributed spin circular dichroism, in which the local spin state linearly changes with the detecting position. The intensity distribution of the central region in the excited SPOV is shown in FIG. 3A, and the spin distribution is shown in FIG. 3B. Specifically for the displacement detection, the region with the best linearity of spin variation is selected, as shown in FIG. 3C. In fact, it is to be understood that the near-field optical vortex field with special distributed spin required for displacement detection is not limited to being produced by the conjugate optical vortex field misalignment superposition technique described in the present disclosure.

At step S102, the local spin state of the NF-OV is coupled to the far-field by using a nanostructure, so as to obtain elliptically polarized light.

Specifically, there are different spin states at different positions in the plane of NF-OV optical field. The local spin state is coupled to the far-field by the nanostructures that are capable of responding to the NF-OV optical field, so as to perform the detection.

At step S103, the spin degree of elliptically polarized light is detected to obtain displacement information of the detecting position.

Specifically, the displacement information of the detecting position can be obtained by detecting the spin degree (or ellipsometry degree or elliptical polarization state) of elliptically polarized light coupled to the far-field.

FIG. 3B is a diagram showing a spin-circular dichroic intensity distribution of the central region in the special SPOV optical field. It can be seen that the spin-circular dichroism exhibits one-dimensional distribution, with no change in the vertical dimension. Therefore, with respect to circular distribution of the radial SPOV optical field, the positional movement in a certain dimension does not affect the detection in the vertical dimension, so that a better practical application can be obtained. FIG. 3C shows the linearity in the optical field used to detect the spin distribution of the displacement detection region. Based on the further analysis of FIG. 3C, it can be found that the method can achieve displacement measurement sensitivity of the order of 10⁻³ Å, the measurement range of the order of hundred nanometers, and the range-accuracy ratio of the order of 10⁵.

The ultrasensitive displacement sensing method based on local spin characteristics according to the present disclosure can obtain displacement information by performing the detection through coupling the local spin state of near-field optical vortex field to the far-field according to the characteristics that the local spin state of near-field optical vortex field linearly changes with the detecting position. The sensing method provided by the present disclosure can obtain accurate displacement information, has high sensitivity, low cost and high practical value.

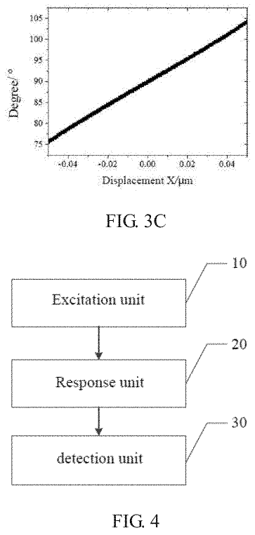

The present disclosure also provides an ultrasensitive displacement sensing device based on local spin characteristics. As shown in FIG. 4, the device includes the following units.

The excitation unit 10 is configured to generate a near-field optical vortex field, NF-OV in which a local spin state linearly changes with a detecting position by excitation of an excitation light.

Specifically, the near-field optical vortex field may be a focusing field with a vortex phase or an evanescent field with a vortex phase.

More specifically, the evanescent field may be a radial surface plasmon optical vortex field, SPOV, or may be a surface plasmon optical vortex field, SPOV with a special distributed spin-circular dichroism after modulation.

When the near-field optical vortex field is a SPOV with a special distributed spin-circular dichroism after modulation, the excitation unit 10 is specifically configured to modulate an incident beam by using a liquid crystal phase modulation slide, to obtain a modulated outgoing beam; and to use the modulated outgoing beam as an excitation light to excite and generate a SPOV with a special distributed spin circular dichroism, in which a local spin state linearly changes with a detecting position.

The incident beam includes a superposed left-handed beam and right-handed beam, the modulated outgoing beam is a beam formed by moving the left-handed beam to the left by a predetermined distance from the center of the incident beam and moving the right-handed beam to the right by a predetermined distance from the center of the incident beam.

A response unit 20 is configured to couple the local spin state of the NF-OV to a far-field by using a nanostructure, so as to obtain elliptically polarized light.

A detection unit 30 is configured to detect the spin degree of elliptically polarized light to obtain displacement information of the detecting position.

It should be noted that the excitation unit 10, the response unit 20, and the detection unit 30 provided by the embodiments of the present disclosure may be implemented by hardware.

The ultrasensitive displacement sensing device based on local spin characteristics according to the embodiment present disclosure can obtain displacement information by performing the detection through coupling the local spin state of near-field optical vortex field to the far-field according to the characteristics that the local spin state of near-field optical vortex field linearly changes with the detecting position. The sensing device provided by the present disclosure can obtain accurate displacement information, and can achieve high sensitivity, low cost and high practical value.

It will be appreciated that the foregoing only describes certain preferred embodiments of the present disclosure, and is not intended to limit the present disclosure. Any modifications, equivalent substitutions and improvements made within the spirit and principles of the present disclosure should be included in the scope of the present disclosure.

1. An ultrasensitive displacement sensing method based on local spin characteristics, comprising:
exciting and generating a near-field optical vortex field, NF-OV by an excitation light, in which a local spin state linearly changes with a detecting position;
coupling the local spin state of the NF-OV to a far-field by a nanostructure, to obtain an elliptically polarized light; and
detecting the spin degree of the elliptically polarized light to obtain displacement information of the detecting position.

2. The ultrasensitive displacement sensing method of claim 1, wherein the near-field optical vortex field is a focusing field with a vortex phase.

3. The ultrasensitive displacement sensing method of claim 1, wherein the near-field optical vortex field is an evanescent field with a vortex phase.

4. The ultrasensitive displacement sensing method of claim 3, wherein the evanescent field is a surface plasmon optical vortex field, SPOV with a special distributed spin circular dichroism after modulation;
wherein the exciting and generating a near-field optical vortex field, NF-OV by an excitation light, in which a local spin state linearly changes with a detecting position, comprises:
modulating an incident beam by a liquid crystal phase modulation slide to obtain a modulated outgoing beam; and using the modulated outgoing beam as an excitation light to excite and generate a SPOV in which a local spin state linearly changes with a detecting position and a special distributed spin circular dichroism;
wherein the incident beam comprises a superposed left-handed beam and right-handed beam, the modulated outgoing beam is a beam formed by moving the left-handed beam to the left by a predetermined distance from the center of the incident beam and moving the right-handed beam to the right by a predetermined distance from the center of the incident beam.

5. An ultrasensitive displacement sensing device based on local spin characteristics, comprising:
an excitation unit configured to excite and generate a near-field optical vortex field, NF-OV by an excitation light, in which a local spin state linearly changes with a detecting position;
a response unit configured to couple the local spin state of the NF-OV to a far-field by using a nanostructure, so as to obtain elliptically polarized light; and
a detection unit configured to detect the spin degree of elliptically polarized light to obtain displacement information of the detecting position.

6. The ultrasensitive displacement sensing device of claim 5, wherein the near-field optical vortex field is a focusing field with a vortex phase.

7. The ultrasensitive displacement sensing device of claim 5, wherein the near-field optical vortex field is an evanescent field with a vortex phase.

8. The ultrasensitive displacement sensing device of claim 7, wherein the evanescent field is a surface plasmon optical vortex field, SPOV with a special distributed spin circular dichroism after modulation;
wherein the excitation unit is specifically configured to modulate an incident beam by using a liquid crystal phase modulation slide, to obtain a modulated outgoing beam; and to use the modulated outgoing beam as an excitation light to excite and generate a SPOV, with a local spin state linearly changing with a detecting position and with a special distributed spin circular dichroism;
wherein the incident beam comprises a superposed left-handed beam and right-handed beam, the modulated outgoing beam is a beam formed by moving the left-handed beam to the left by a predetermined distance from the center of the incident beam and moving the right-handed beam to the right by a predetermined distance from the center of the incident beam.
